(19) United States
(12) Patent Application Publication
(10) Pub. No.: US 2006/0186630 A1
(43) Pub. Date: Aug. 24, 2006

(54) Effort-saving bicycle and transmission crank

(75) Inventor: Chin-Chien Yuan, Taipei County (TW)

Correspondence Address: BACON & THOMAS, PLLC, 625 SLATERS LANE, FOURTH FLOOR, ALEXANDRIA, VA, 22314, US

(73) Assignee: Chin-Chien Yuan, Taipei County (TW)

(21) Appl. No.: 11/326,495

(22) Filed: Jan. 6, 2006

(30) Foreign Application Priority Data
Feb. 22, 2005 (TW) 94202795

(51) Int. Cl. B62M 1/02

(52) U.S. Cl. 280/259; 74/594.1

(57) ABSTRACT

This invention provides an effort-saving bicycle and transmission cranks comprising: a frame; two wheels pivotably disposed respectively on a front side and rear side of a lower portion of the frame; a gear-driving disc pivotably disposed proximate to a central portion of a lower portion of the frame; a handlebar installed on a front side of an upper portion of the frame; a seat pad installed proximate to a central portion of an upper portion of the frame; two cranks each of which having one end pivotably disposed at a transmission axle of two sides of the gear-driving disc; two pedals pivotably disposed respectively on the other ends of the two cranks. A force-applied point of the crank may in advance effectively pass through an upper death point and defer passing through a lower death point upon performing a circumferential stepping movement at the pedals, and eliminating a death angle coming from a maximum force-applied point upon performing a circumferential stepping movement at the pedals.

### BACKGROUND OF THE INVENTION

1. Field of the Invention

The present invention relates to an effort-saving bicycle and transmission cranks, and especially to a bicycle having effort-saving transmission cranks.

2. Description of the Related Art

Due to light-weighted, convenience and economical characteristic, bicycles have been widely used as transportation vehicles over one hundred years and become convenient transportation vehicles now. Force needs to be applied on the pedals of the bicycle so as to drive the wheels of the bicycle to rotate by a link chain and making the bicycle advance. Among other things, the bicycles are not replaceable in high-level leisure entertainment and exercise for health at the present day. As persisting evolution of science and technology, the life will be changed and the environment also will be changed. However, an environment-protective bicycle will be able to continue making happiness and bringing convenience in the daily life.

Referring to FIG. 1 and FIG. 2, a side view of a conventional bicycle and a partial enlarged view of cranks and pedals of the conventional bicycle are respectively shown. The crank 1 of the conventional bicycle has a linear design. One end of the crank 1 is pivotably connected to a transmission axle 3 of a gear-driving disc 2. As such, when the bicycle is driven to make circumferential stepping movements, the pedals 4 are stepped down and transfer a motive power to a front driving gear 5 by rotating the transmission axle 3 via the crank 1, and the bicycle is driven. Using the motive power generated by the crank 1 to rotate the front driving gear 5 via the transmission axle 3 adopts the theory of an effort-wasting lever. However, during the circumferential stepping movements performed on the bicycle, when the pedals 4 pass through an upper death point (the highest position of the pedals 4), the force-applied points of the pedals 4 and the crank 1 are simultaneously in a vertical line with the transmission axle 3, and a maximum force-applied point, indicated by an arrow F, will exist here. Because the applied force F, the crank 1 and the transmission axle 3 are in the vertical line, the lever torque at the maximum force-applied point will equal to zero, at this point, the forces exerted by the legs of a rider will reach the maximum, but the mechanical power output is the minimum. This position is the most effort-wasting position at which the forces exerted by the legs of the rider reach the maximum during the circumferential stepping movements performed on the bicycle. Moreover, the legs of the rider need to repeatedly perform the circumferential stepping movement to drive the bicycle, however, when the leg repeatedly reaches the upper death point at which an instantaneous maximum force exerts, the leg muscle is easy to be weary. Such a conventional design of the bicycle transmission system is easy to lose the mechanical motive power. The forces exerted by the legs of the rider have huge differences. The rider easily gets tired and the efficiency for driving the bicycle is relatively worse.

### SUMMARY OF THE INVENTION

It is one objective of the present invention to provide a transmission mechanism for a bicycle, which can rapidly drive the bicycle and achieve the performances of saving effort and smoothness.

It is another objective of the present invention to provide a bicycle with a transmission crank having an effective force-applied arm, which can rapidly drive the bicycle and achieve the performances of saving effort and smoothness.

In order to achieve the above-mentioned objectives, a bicycle according to the present invention comprises a frame; two wheels pivotably disposed respectively on a front side and rear side of a lower portion of the frame; a gear-driving disc pivotably disposed proximate to a central portion of a lower portion of the frame; a handlebar installed on a front side of an upper portion of the frame; a seat pad installed proximate to a central portion of an upper portion of the frame; two cranks each of which having one respective end pivotably disposed at a transmission axle of two sides of the gear-driving disc; two pedals pivotably disposed on the other respective ends of the two cranks. When circumferential stepping movements are performed on the pedals of the bicycle, a force-applied point of the crank may in advance effectively pass through an upper death point upon performing a circumferential stepping movement and defer passing through a lower death point, and a death angle of a maximum force-applied point upon performing a circumferential stepping movement is eliminated.

Preferably, the crank has at least one hole.

Preferably, a bolt is provided for passing through the hole of the crank.

### BRIEF DESCRIPTION OF THE DRAWINGS

FIG. 1 shows a side view of a conventional bicycle.

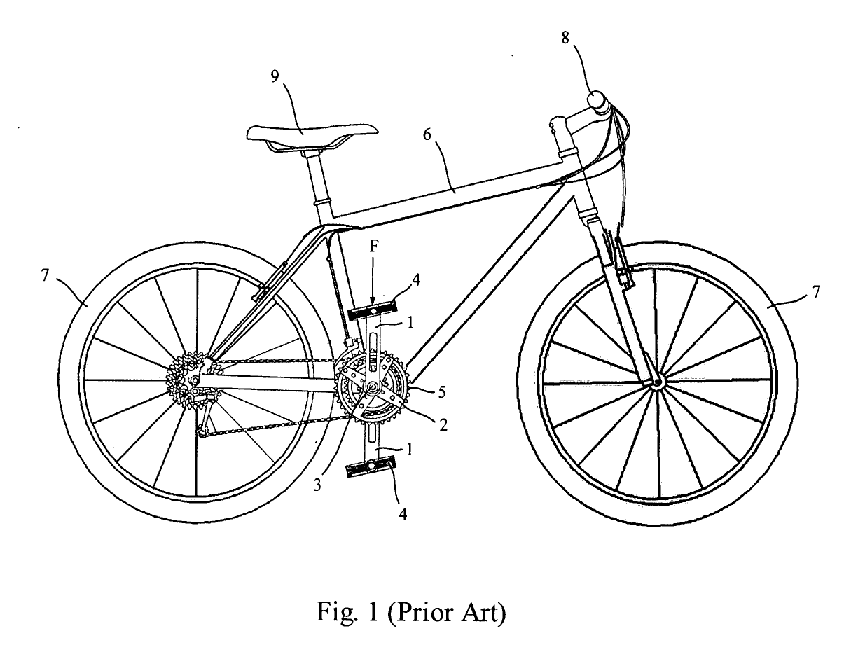

FIG. 2 shows a partial enlarged view of the cranks and pedals of the conventional bicycle of FIG. 1.

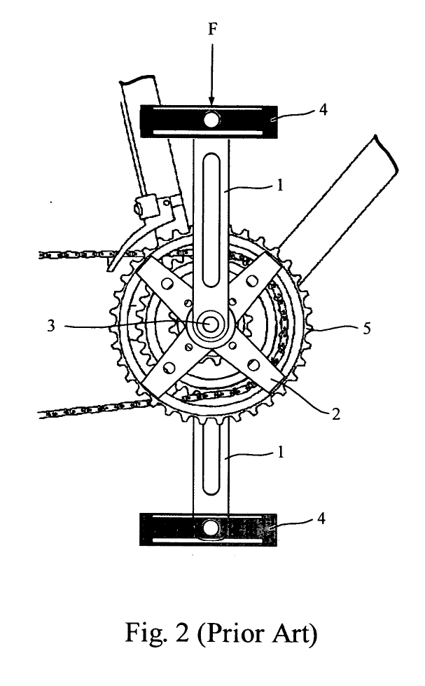

FIG. 3 shows a side view of a bicycle according to the present invention.

FIG. 4 shows a partial enlarged view of curved cranks and pedals of the present bicycle of FIG. 3.

FIG. 5 is a diagram showing a force is applied at a force-applied arm of the present bicycle.

FIG. 6 shows a perspective view of a curved crank of the present invention.

FIG. 7 shows a perspective view of an L-shaped crank according to another embodiment of the present invention.

### DETAILED DESCRIPTION OF THE PREFERRED EMBODIMENTS

Although the present invention has been described in considerable detail with reference to certain preferred embodiments thereof, however prior to this description, it should be understood that those skilled in the art can easily make changes to the present invention described herein and the same performance as the present invention is obtained. Therefore, it is to be understood that the following description is a general disclosure to those skilled in the art and is not restrictive of the present invention.

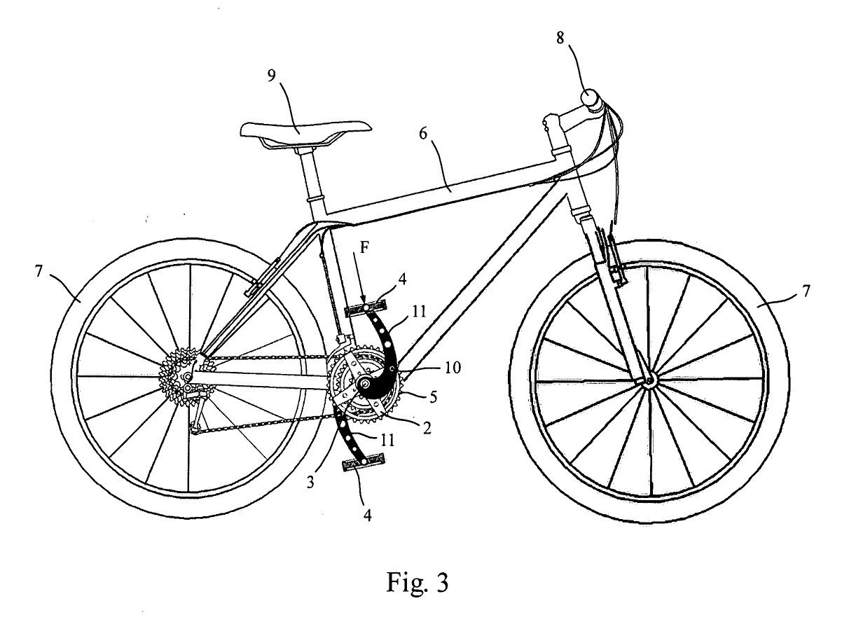

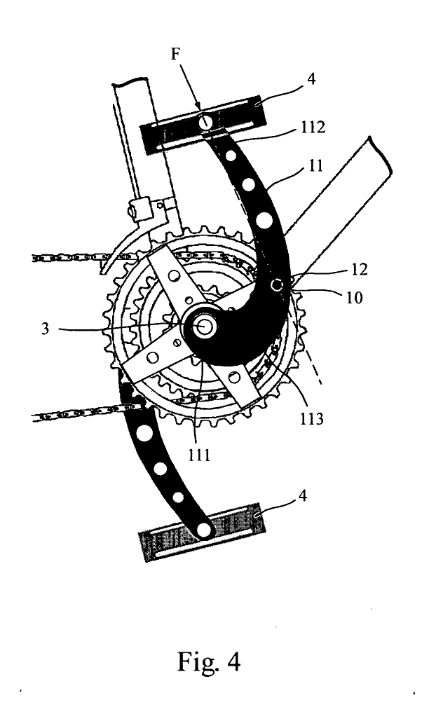

Referring to FIG. 3 and FIG. 4, a side view of the bicycle according to the present invention and a partial enlarged view of curved cranks and pedals of the present bicycle are respectively shown. The bicycle of the present invention comprises a frame 6; two wheels 7 pivotably disposed respectively on a front side and rear side of a lower portion of the frame 6; a gear-driving disc 2 pivotably disposed proximate to a central portion of the lower portion of the frame 6; a handlebar 8 installed on a front side of an upper portion of the frame 6; a seat pad 9 installed proximate to a central portion of the upper portion of the frame 6; two curved cranks 11, a first end 111 of one of the cranks 11 is pivotably disposed at the transmission axle 3 outside the gear-driving disc 2, the curved crank 11 has a hole 12, the curved crank 11 is fixedly connected to the gear-driving disc 2 by passing a bolt 10 through the hole 12, and the first end 111 of the curved crank 11 extends outwardly in a radial direction to an angle and forms a curved portion 113; and two pedals 4 pivotably disposed at respective second ends 112 of the two cranks 11.

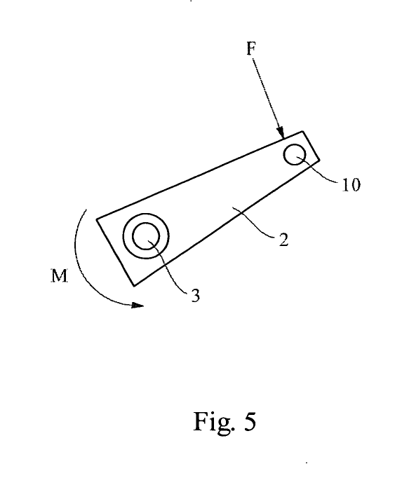

Continuing referring to FIG. 4 in conjunction with FIG. 5, the force applied on the force-applied arm of the present bicycle is diagrammatically shown. When circumferential stepping movements are performed on the pedals 4, an applied force F (indicated by an arrow) on the pedals 4 is applied to the force arm formed by the transmission axle 3 and the bolt 10, and hence the applied force F is applied to the position of the hole 12 along the applying direction (indicated by a dotted line in FIG. 4). At this time, a torque is generated at the transmission axle 3, and the applied force F on the pedals 4 is transferred to the bolt 10, and generating a motive power to directly drive and rotate the gear-driving disc 2 to move ahead the bicycle. Using the motive power at the bolt 10 to directly drive and rotate the gear-driving disc 2 adopts the theory of an effort-saving lever. In this way, the loss of the motive power is reduced, the rider does not easily get tired, and the riding efficiency is increased.

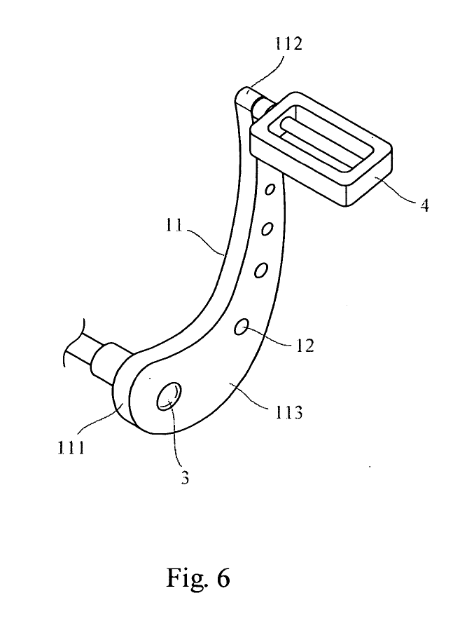

Referring to FIG. 6, a perspective view of a curved crank 11 of the present invention is shown. The curved crank 11 comprises a crank body having a first end 111 and a second end 112 and a curved portion 113. The first end 111 of the crank body extends outwardly in a radial direction to an angle and forms the curved portion 113. The curved portion 113 is used as a force arm.

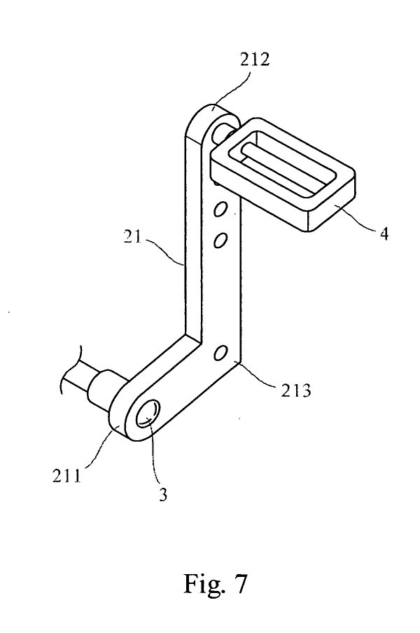

Referring to FIG. 7, a perspective view of an L-shaped crank according to another embodiment of the present invention is shown. The L-shaped crank 21 comprises a crank body having a first end 211 and a second end 212 and an L-shaped portion 213. The first end 211 extends outwardly in a radial direction to form a first force arm. The second end 212 extends outwardly in a radial direction to form a second force arm longer than the first force arm. The first force arm and second force arm are connected to each other to form the L-shaped portion 213.

The advantages of the present invention are that the force-applied point of the curved crank or the L-shaped crank may in advance effectively pass through an upper death point upon performing a circumferential stepping movement on the pedals and defer passing through a lower death point. As such, a death angle coming from the maximum force-applied point upon performing a circumferential stepping movement on the pedals is effectively eliminated, and the resulting torque can perform a better lever theory when the curved crank or the L-shaped crank is moved. Accordingly, when the legs of a rider perform the circumferential stepping movement to drive the bicycle, the curved crank or the L-shaped crank can have an effort-saving, smooth, and rapid performance in operation, such that the performances of saving effort, smoothness and high speed can be obtained upon ridding the bicycle.

Having described the preferred embodiments of this invention, it should be readily apparent to those skilled in the art that the invention can be modified and changed without departing from the scope and spirit of this invention as defined in the appended claims. Further, this invention is also not limited to the implementations of the embodiments disclosed in this specification.

What is claimed is:

1. A bicycle, comprising:
a frame;
two wheels pivotably disposed respectively on a front side and rear side of a lower portion of said frame;
a gear-driving disc pivotably disposed proximate to a central portion of the lower portion of said frame;
a handlebar installed on a front side of an upper portion of said frame;
a seat pad installed proximate to a central portion of an upper portion of said frame;
two transmission cranks each of which having a first end and a second end, said first end pivotably disposed at a transmission axle outside said gear-driving disc; and
two pedals each of which pivotably disposed on said second end of said transmission cranks;
characterized in that a curved portion is formed between said first end and said second end and is extended outwardly in a radial direction from said first end to form an angle.

2. The bicycle as claimed in claim 1, wherein said curved portion of said transmission crank is provided with at least one hole.

3. The bicycle as claimed in claim 1, further comprising a bolt passing through the hole of said transmission crank and fastening said transmission crank on said gear-driving disc.

4. The bicycle as claimed in claim 2, further comprising a bolt passing through the hole of said transmission crank and fastening said transmission crank on said gear-driving disc.

5. A bicycle, comprising:
a frame;
two wheels pivotably disposed respectively on a front side and rear side of a lower portion of said frame;
a gear-driving disc pivotably disposed proximate to a central portion of the lower portion of said frame;
a handlebar installed on a front side of an upper portion of said frame;
a seat pad installed proximate to a central portion of an upper portion of said frame;
two transmission cranks each of which having a first end and a second end, said first end pivotably disposed at a transmission axle outside said gear-driving disc; and
two pedals each of which pivotably disposed at said second end of said transmission cranks;
characterized in that said first end extends outwardly in a radial direction to form a first force arm and said second end extends outwardly in a radial direction to form a second force arm longer than said first force arm, and said first force arm connects with said second force arm to form an L-shaped portion.

6. The bicycle as claimed in claim 5, wherein a hole is formed at a connecting section of said first force arm and said second force arm of said transmission crank.

7. The bicycle as claimed in claim 5, further comprising a bolt passing through the hole of said transmission crank and fastening said transmission crank on said gear-driving disc.

8. The bicycle as claimed in claim 6, further comprising a bolt passing through the hole of said transmission crank and fastening said transmission crank on said gear-driving disc.

9. A transmission crank rotatably holding at a transmission axle center of a gear-driving disc of a bicycle frame, wherein said transmission crank has a crank body, said crank body has a first end and a second end, and a curved portion is formed between said first end and said second end and is extended outwardly in a radial direction from said first end to form an angle.

10. The transmission crank as claimed in claim 9, wherein said curved portion is formed with at least one hole.

11. The transmission crank as claimed in claim 10, wherein a bolt passes through said hole such that said transmission crank is fastened to said gear-driving disc.

12. A transmission crank rotatably holding at a transmission axle center of a gear-driving disc of a bicycle frame, wherein said transmission crank has a crank body, said crank body has a first end and a second end, said first end extends outwardly in a radial direction to form a first force arm, said second end extends outwardly in a radial direction to form a second force arm longer than said first force arm, said first force arm and second force arm are connected to form a L-shaped portion.

13. The transmission crank as claimed in claim 12, wherein a hole is formed at a connecting section of said first force arm and said second force arm of said transmission crank.

14. The transmission crank as claimed in claim 13, wherein a bolt passes through the hole such that said transmission crank is fastened to said gear-driving disc.
